(19) United States
(12) Patent Application Publication
(10) Pub. No.: US 2025/0259341 A1
(43) Pub. Date: Aug. 14, 2025

(54) SYSTEMS AND METHODS FOR MANAGING AND DISPLAYING HANDHELD OBJECTS IN VIDEO CAPTURE

(71) Applicant: Adeia Guides Inc., San Jose, CA (US)

(72) Inventors: Zhiyun Li, Kenmore, WA (US); Ning Xu, Irvine, CA (US); Toshiro Ozawa, Irvine, CA (US); Aldis Sipolins, Somerville, MA (US)

(21) Appl. No.: 18/662,177

(22) Filed: May 13, 2024

Related U.S. Application Data
(60) Provisional application No. 63/552,729, filed on Feb. 13, 2024.

(51) Int. Cl. G06T 11/00; G06V 20/40

(52) U.S. Cl. CPC G06T 11/00; G06V 20/40

(57) ABSTRACT

The present application provides for a video system that displays handheld objects in video capture by detecting objects being held by the user within a segmentation mask and adding the object to an allowed list of permissibly visible objects. The system may be configured, during live video capture, to show or hide selected objects. As an added advantage, such approaches are not dependent on whether the hand is holding the object and moving synchronously. For example, if a video application on a video system included a pen in the allowed list, and the user waves and rotates the pen such that the pen moves out of sync with the body of the user, the video system will still make the pen visible. Moreover, the video application provides an efficient object detection mechanism that detects the handheld object once the object is placed within the segmentation mask.

### CROSS-REFERENCE TO RELATED APPLICATION

This application claims benefit of U.S. Provisional Application No. 63/552,729, filed Feb. 13, 2024. The disclosure of referenced application is hereby incorporated by reference herein in its entirety.

### BACKGROUND

This disclosure is related to systems and methods for user interfaces in video capture mediums.

### SUMMARY

Video capture systems are often used to create online video conferences. For example, in a video conference, the video system captures videos from several devices and transmits the video feeds to all devices participating in a conference. In some approaches the video system provides a virtual background effect. In some approaches, the virtual background effect is enabled for all parts of video feed from a device of a user, such that, other than an outline of the user, the entire background is replaced with parts of a virtual background such that other devices on the conference receive video of the user overlaid over a virtual background. However, with the virtual background enabled, it is often difficult for the video to appropriately handle display of an object held by the user. For example, the object may rapidly and randomly oscillate between being replaced by the virtual background or being visible. This creates poor picture quality due to flickering. Moreover, the problem of handling such held objects by a video capture system is made more difficult because sometimes it is desirable to have the object of a user be visible (e.g., when that object used as visual aid), while at other times, the object is superfluous and should not be visible.

In some approaches, a machine learning model (e.g., a deep learning model) is trained with examples to find the silhouette of the user. This resulting shape may be referred to as a “segmentation mask.” In some embodiments, the deep learning model is configured to not include any arbitrary object held by the user. In such approaches, objects outside of the silhouette-based mask are always replaced with virtual background. This is problematic as objects are routinely used as visual aids during online video conferences, and these user interfaces with automatic negation of any handheld object do not provide the desired functionality required. Given these user interface limitations, the system can then either be configured to not have a virtual background at all to allow the handheld object (and all other objects) to be visible, or the system can be configured to apply the virtual background even when imperfect and fails to show any handheld visual aids. Both solutions lead to suboptimal functionality of the system, i.e., either the background replacement feature is not used at all, or the background replacement feature is used, but handheld visual aids cannot be shown.

In some embodiments, for the video system to include the handheld object in the segmentation mask, the system trains a deep learning model specifically for a user holding the specific object. Such approaches operate on the assumption that the pixels of the handhold object are moving synchronously with pixels of the hand (e.g., the object is moving at the same time as the hand). This approach is deficient because it is not always true that handheld objects always move synchronously with the user (e.g., the object may be moving in a different direction than the hand or moving at a different rate of speed). Consequently, this may break the detection provided by the specifically trained model. Moreover, in such implementations, the system fails to provide the user with a user interface that enables a choice of whether to show or hide the object.

To overcome these problems, systems and methods are provided herein for video system and a user interface for this system that displays handheld objects in video capture by detecting objects being held by the user within the segmentation mask (e.g., a mask that is based on silhouette of a user) and adding the object to an allowed list of permissibly visible objects. When using such user interface of the video system, the system may be configured, during live video capture, to show or hide selected objects. As an added advantage, such approaches are not dependent on whether the hand is holding the object and moving synchronously. For example, if a video application on a video system included a pen in the allowed list, and the user waves and rotates the pen such that the pen moves out of sync with the body of the user, the video system will still make the pen visible. Moreover, the video application provides an efficient object detection mechanism that detects the handheld object once the object is placed within the segmentation mask. In some embodiments, the video system may also be demarcated via a designated object recognition zone which may be near the user.

In some embodiments, the video application may access a video capture and generate a segmentation mask based on a user region. For example, a participant (which may be a host participant or any video conference participant) creates a video conferencing session where the video application generates a segmentation mask based on the region of the participant's body. The video application may then replace portions of the video capture outside the segmentation mask with a virtual background. For example, the participant may use the video application to select a virtual background from a graphical user interface that provides for a solar system virtual background for privacy purposes as to not show their personal space to a large online audience. The participant is then shown in front of a solar system background within the video conferencing session. A first object held by the user within the segmentation mask may be detected by the video application and added to a list of allowed objects. For example, the participant may be holding a Rubik's cubeRubik's cube as a visual aid for the video conferencing session and then pull the Rubik's cubeRubik's cube within their silhouette. Upon detecting the user holding the Rubik's cubeRubik's cube within their silhouette, the video application adds the Rubik's cubeRubik's cube to the list of allowed objects of handheld objects that are permissible to be visible outside the participant's silhouette.

In some embodiments, the video application may detect a second object being held by the user in the video capture and determine whether this second object is listed within the list of allowed objects, and if so, it will modify the video capture to not replace the second object with the virtual background allowing it to be visible. For example, if, after the participant puts the Rubik's cubeRubik's cube down (rendering the Rubik's cubeRubik's cube no longer visible as it is covered by the virtual background), the participant picks the Rubik's cubeRubik's cube back up, then the video application verifies that the Rubik's cubeRubik's cube is listed in the list of allowed objects and allows for the Rubik's cubeRubik's cube to be visible and does not replace it with the solar system virtual background.

In some embodiments, the video application may determine that that the second object is not being held by the user, and the second object is outside of the segmentation mask. In this scenario, the video application modifies the video capture to replace the second object with the virtual background. For example, If the participant puts down the Rubik's cube outside of their silhouette, the Rubik's cube is not visible and is replaced with the solar system virtual background. In some embodiments, the replacing of the second object with the virtual background is performed gradually increasing the transparency of the second object until the object is fully transparent.

In some embodiments, the video application may generate an interface that has identifiers of objects from the list of allowed objects. For example, if the Rubik's cube is an object within the list of allowed objects, a miniature icon having a visual representation of a Rubik's cube may be placed within an allowed list interface bar overlayed on top of the video capture to provide further functionality of the allowed object list by interacting with the miniature icon in the allowed list interface bar. In some embodiments, the video application may receive a selection of a selected object from the list of allowed objects to add the selected object to an object blocked list. For example, the participant may want to be able to pick up their smartphone to check personal messages but also have their phone not be visible whether it be within or outside of the participant's silhouette. In some embodiments, the video application may, upon adding an object to the list of allowed objects, determine that maximum threshold for the list of allowed objects has been exceeded. If so, the video application may modify the list of allowed objects to remove the least recently used object within the list of allowed objects. For example, the participant may use a number of objects including a Rubik's cube, a binder, and a cup. If the list of allowed objects maximum threshold is set to three, then only three objects may exist within the list of allowed objects. If the participant then adds a smartphone to the list of allowed objects, the binder (which is the least recently used object within the allowed list) is removed from the list of allowed objects while the smartphone is added.

In some embodiments, the video application may process an audio input to determine that a word in the audio input is related to the detected first object. Based on the first object, being held by the user within the segmentation mask and the related word in the audio input, the detected object may be added to the list of allowed objects. For example, the participant uses the Rubik's cube in the video conferencing session and brings the Rubik's cube within the participant's silhouette and mentions that “this Rubik's cube can be used to accurately measure the lengths of the majority of caterpillars in one's yard.” Given the word “Rubik's cube” was detected as audio input, and the Rubik's cube was visually detected within the silhouette, the Rubik's cube is added to the list of allowed objects. In some embodiments, a trained machine learning model may be used to determine the word in the audio input is related to the detected first object based on inputting the audio input and video capture into the trained machine learning model.

In some embodiments, the video application may implement a machine learning model that segments the user region from the first object, being held by the user, within the segmentation mask. In some embodiments, NLP is implemented to analyze audio inputs to confirm the first object.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative scenario in which an object is added to a list of allowed objects, in accordance with some embodiments of this disclosure.

FIG. 2 shows an illustrative scenario in which an object is added to a list of allowed objects via an object recognition zone, in accordance with some embodiments of this disclosure.

FIG. 3 shows an illustrative scenario of user interface interaction to modify an object, in accordance with some embodiments of this disclosure.

FIG. 4 shows an illustrative scenario of an interface implementing a least recently used object condition, in accordance with some embodiments of this disclosure.

FIG. 5 shows illustrative user equipment devices, in accordance with some embodiments of this disclosure.

FIG. 6 shows illustrative systems, in accordance with some embodiments of this disclosure.

FIG. 7 is a flowchart of a detailed illustrative process for modifying the video capture such that the second object is not replaced by the virtual background, in accordance with some embodiments of this disclosure.

FIG. 8 is a flowchart of a detailed illustrative process for modifying the video capture such that the third object is replaced by the virtual background, in accordance with some embodiments of this disclosure.

FIG. 9 is a flowchart of a detailed illustrative process for modifying the list of allowed objects to remove the least recently used object within the object list of allowed objects, in accordance with some embodiments of this disclosure.

FIG. 10 is a flow diagram of a detailed illustrative process for applying a segmentation mask, in accordance with some embodiments of this disclosure.

FIG. 11 is a flow diagram of another detailed illustrative process for applying a segmentation mask, in accordance with some embodiments of this disclosure.

### DETAILED DESCRIPTION

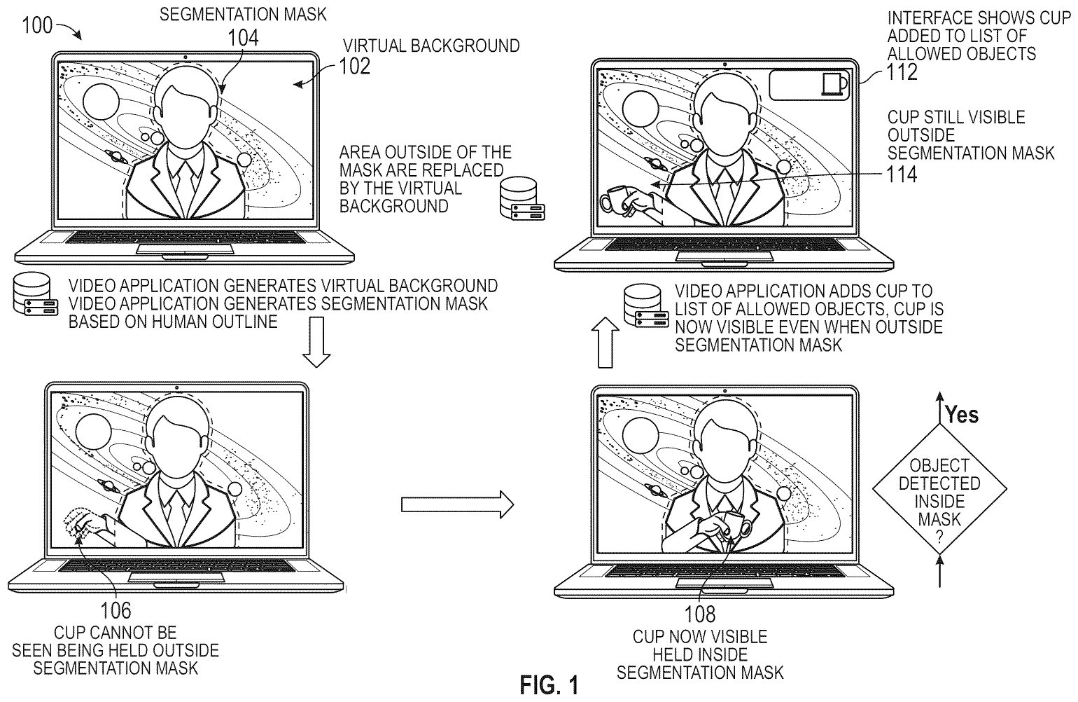

FIG. 1 shows an illustrative scenario 100 in which an object is added to a list of allowed objects, in accordance with some embodiments of this disclosure. A video application may operate on a video system. The video system may be any user equipment that has control circuitry for processing and communication circuitry to interface with other user devices for display and interaction of a video capture. The video application may be a software application operating on the video system. In some embodiments, the video application accesses a video capture. For example, a video application running on a laptop computer may access a video conferencing feed, as shown in FIG. 1. The video capture may be live video, a stored live video, recorded video, or any other type of video capture. In some embodiments, the video application detects a user region of a user in the video capture. In some embodiments, the video application generates a segmentation mask based on a user region. Continuing from the example above, the video application may implement computer vision techniques to demarcate the user from the background of the video conferencing feed. In some embodiments, the implemented techniques may be active only on portions of the frame that are different from the previous frame to optimize computing resources. For example, if the user is standing in front of their bedroom, a computer vision technique that analyzes each frame of a video sequence to determine the human from a background may be implemented to determine the demarcation of the user. The user region that demarcates the user from the background is called a segmentation mask. In FIG. 1, the segmentation mask 104 demarcates the user from the background.

In some embodiments, the video application may modify the video capture, to replace portions of the video capture outside of the segmentation mask with a virtual background. A virtual background may include a static background, a dynamic background, or a modified visual effect applied to the transmitted background. In FIG. 1, the virtual background is a solar system representation. In FIG. 1, the area outside the segmentation mask 102 may be referred to as a virtual background.

In some embodiments, the video application may detect in the video capture a first object being held by the user, within the segmentation mask that is based on the detected user region. In some embodiments, the detection of the object being held may be implemented by a machine learning model trained with data of users holding a variety of objects. In FIG. 1, at 106, the user is holding a cup (e.g., a first object) outside the segmentation mask and the object is not visible. It should be noted that the hand showing at 106 may be rendered in a few variants as the segmentation mask had that portion of the hand hidden behind the cup and thus the appearance of the hand behind the cup is unknown. Although the thumb is actually rendered (as it was always visible), the portion behind the thumb requires rendering. In some embodiments, the video application may render the hand as missing without any further manipulation. In some embodiments, the video application may render the hand hidden behind the cup using a rendering method such as generative AI to approximate a likely render given the portion of the hand that is known. For example, the video application may use generative AI rendering to include information such as skin tone, relative sizing and ratios, hair patterning, and other cues can be used to generate a more accurate representation of the missing part of the hand. However, at 108, the video application detects the user is holding the cup within their own silhouette (e.g., segmentation mask). In some embodiments, the video application may add the first object to a list of allowed objects. The list of allowed objects may include permissible objects that are to be visible outside the segmentation mask. For example, the user may deliberately intend to hold specific objects and have them be visible outside their silhouette. The list of allowed objects may be a data structure that is stored in a computer memory. In FIG. 1, at 112, the video application generates for display an interface showing the cup being added to the list of allowed objects. Moreover, the user is holding the cup outside of his silhouette while the cup remains visible and is not replaced with the virtual background as the cup is in the list of allowed objects. In some embodiments, the video application may detect the user pointing to the detected object. In response to the user pointing to the detected object, the video application adds the detected object to the list of allowed objects.

In some embodiments, the video application may detect, in the video capture, a second object being held by the user outside of the segmentation mask. For example, the user may put down the cup (e.g., first object). A short time later, the user may pick up the cup again (e.g., second object). In this example, the second object is the same as the first object. In some embodiments, the video application may determine that the second object is listed in the list of allowed objects. For example, if the second object is the cup, the video application may determine that “cup” is within the list of allowed objects. In some embodiments, the video application may then modify the video capture such that the second object is not replaced by the virtual background. Continuing with the example above, the cup is not replaced with the virtual background.

In some embodiments, if the video application determines that that the second object is not being held by the user, and that the second object is outside of the segmentation mask that is based on the detected user region, then the video application modifies the video capture to replace the second object with the virtual background. For example, if the user lets go of the cup to stand on the tabletop, then the cup (not being held by the user) would be replaced by the virtual background. In some embodiments, the video application, when replacing the second object with the virtual background, gradually increases transparency of the second object until the second object is fully transparent. For example, if the user puts the cup down, the cup has a visual effect applied such that the cup slowly fades to become transparent. Once transparent, only the virtual background shows in place of the cup.

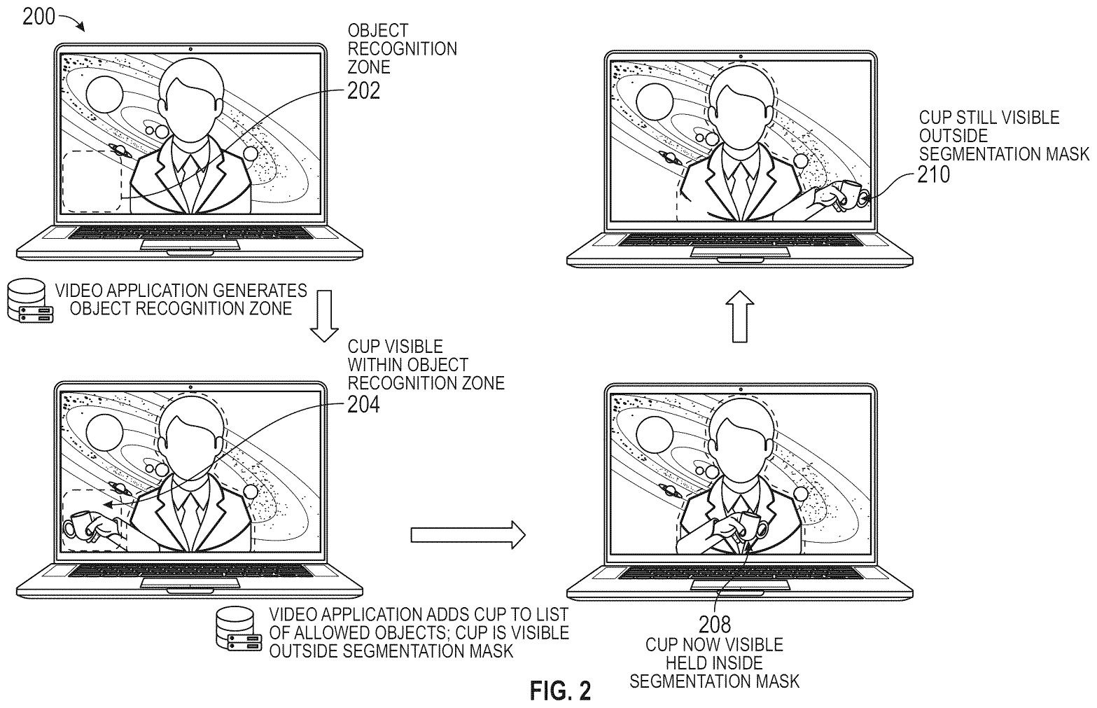

In some embodiments, the video application may generate for display an indication of designated object recognition zone. An object recognition zone may be any zone that functions similar to a segmentation mask. The shape of the zone may be any geometric shape or representation. For example, if an object is brought within the object recognition zone, the object is added to the list of allowed objects. FIG. 2 shows an illustrative scenario 200 in which an object is added to a list of allowed objects via an object recognition zone, in accordance with some embodiments of this disclosure. At 202, an object recognition zone is shown in the bottom left of the screen. In some embodiments, the video application may, in response to detecting in the video capture a third object being held by the user within the designated object recognition zone, add the third object to the list of allowed objects. At 204, the user is holding the cup (e.g., the third object) in the object recognition zone. The cup is added to the list of allowed objects. At 208, because the cup was added to the list of allowed object, the cup is visible within the user's silhouette at 208 and also visible outside the silhouette 210.

In some embodiments, the video application may generate for display an interface that includes identifiers of one or more objects within the list of allowed objects. In some embodiments, the interface may be a menu that is overlayed onto the virtual background. In some embodiments, the interface may include identifiers of the one or more objects. In some embodiments, the identifiers may be visual representations, alphanumeric representations, or symbolic representations. For example, the identifier for the cup may be an icon having similar visual representation of a cup. In some embodiments, the identifiers may be user-generated content. In some embodiments, the identifiers may be emojis. In some embodiments, the interface may be positioned at any position within the virtual background and/or the user. In some embodiments, the interface may be visible to a single user of the video application. In other embodiments, the interface may be visible to a plurality of users of the video application. For example, in a video conferencing meeting, the interface may be just visible to the participant that is hosting (e.g., a presentation where there is only one speaker) of the video conferencing meeting. Or alternatively, the interface may be visible to all participants of the video conferencing meeting (e.g., a group discussion where everyone is equally active). In some embodiments, the interface that displays the list of allowed objects is cleared after the video capture session is completed. In some embodiments, the interface that displays the list of allowed objects is preserved after the video capture session is completed for one or more future sessions. In some embodiments, in a video capture that has a plurality of users, the video application may configure the interface such that each of the users has a separate list of allowed objects that is configurable by each respective user of the plurality of users.

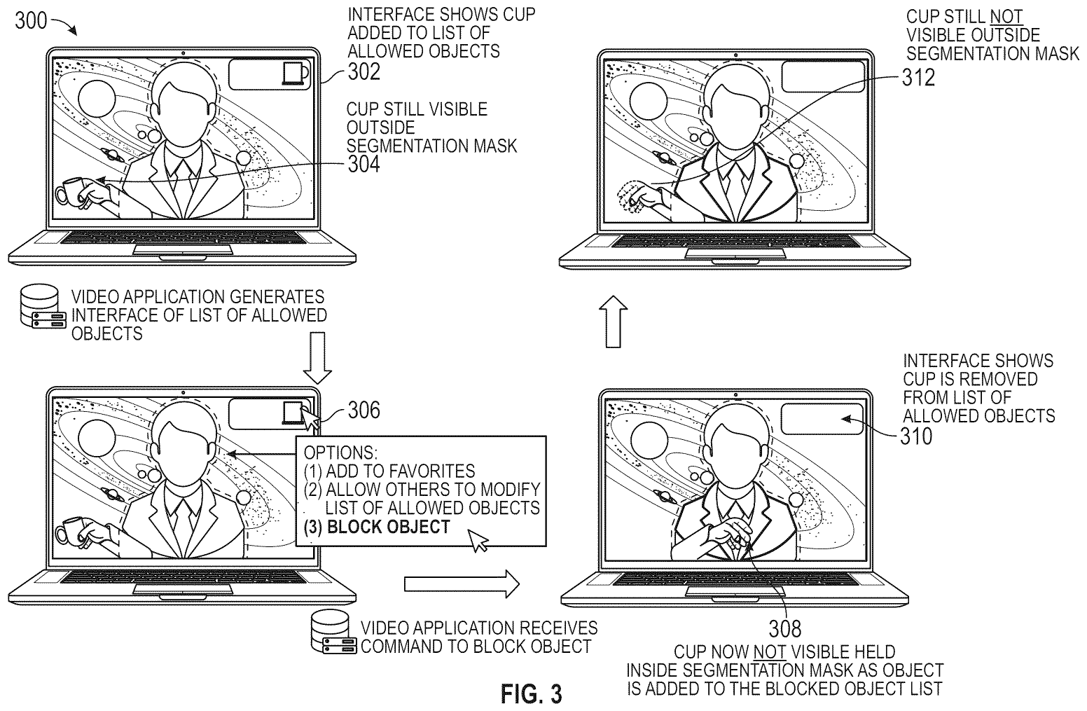

In some embodiments, the video application may receive a selection from the interface of a selected object from the list of allowed objects. FIG. 3 shows an illustrative scenario 300 of user interface interaction to modify an object, in accordance with some embodiments of this disclosure. At 302, the video application interface includes a rounded rectangle region that has identifiers of allowed objects within this region. An icon of a cup is shown to be within the list of allowed objects representing the cup object. At 306, the video application receives a user selection of the icon of the cup which opens a menu of further functionality. The further functionality includes options to add to favorites, allow others to modify list of allowed objects, or block object.

In some embodiments, the video application may receive a command to add the selected object to a blocked objects list. Continuing with FIG. 3, the video application receives a command to block the cup object. At 308, the cup object is blocked such that the virtual background and/or the user covers the cup object. In this way, the cup object is never visible. Additionally, the interface no longer has the icon of the cup within the list of allowed objects. Even if the cup is brought outside the segmentation mask 312, it would still not be visible. In some embodiments, the video application may analyze frames to create a mask over a blocked object by replacing the pixels of the object with the same pixels from a frame without the object located at these same pixels. In some embodiments, the video application may detect in the video capture a third object, being held by the user, within the segmentation mask that is based on the detected user region. For example, if the cup (e.g., second object) was put down, and sometime later the cup was picked up again (e.g., third object), the cup is detected. The video application may determine that the third object (e.g., cup) matches one of the objects within the blocked object list (e.g., cup). If so, the video application may modify the video capture such that the third object (e.g., cup) is modified to be transparent. For example, if the cup is blocked, and it's determined the third object is a cup, then the cup is modified to be completely transparent and let the virtual background and/or the user cover the cup. In some ways, the video application may utilize the blocked object functionality to negate false positives of objects that are added into the list of allowed objects that should not be part of the list of allowed objects.

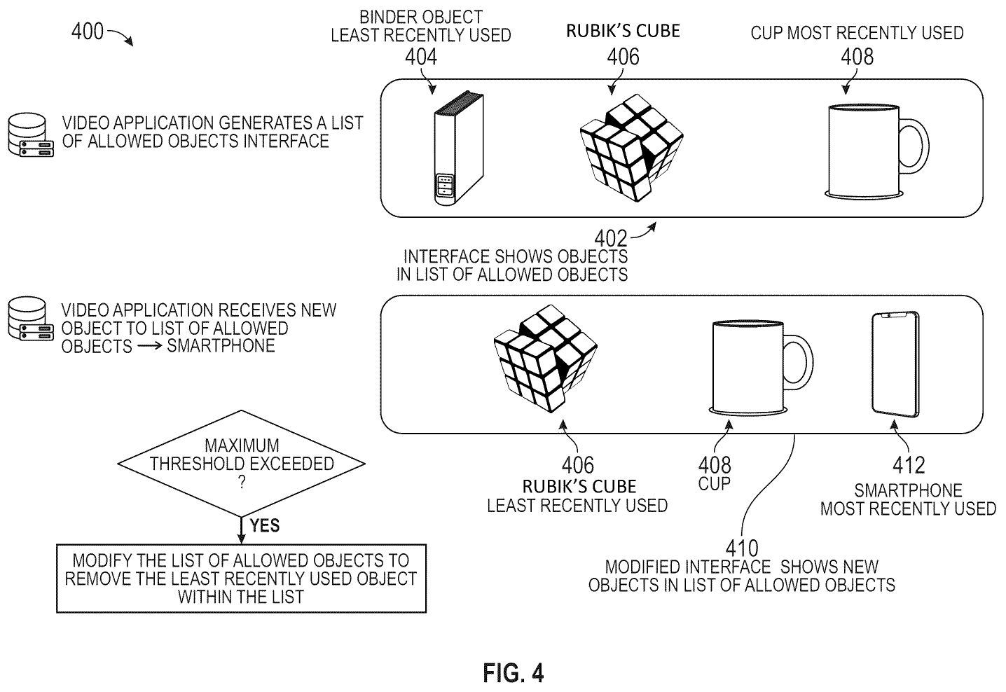

In some embodiments, the video application may detect in the video capture a third object being held by the user within the segmentation mask that is based on the detected user region. The video application may add the third object to the list of allowed objects. If the maximum threshold is exceeded for the list of allowed objects, the video application modifies the list of allowed objects to remove the least recently used object within the list of allowed objects. FIG. 4 shows an illustrative scenario 400 of an interface implementing a least recently used object condition, in accordance with some embodiments of this disclosure. The video application generates a list of allowed objects interface 402 which includes three objects namely, a binder 404, a Rubik's cube 406, and a cup 408. In this example, this particular interface integrates a least recently used (i.e., LRU) object functionality to limit the amount of objects within the list of allowed objects. In a LRU data structure, the objects that are not frequently used (e.g., selected for use by the user) are relegated in priority relative to other objects that are more frequently used. The object that is not used may become the least used object in the data structure. Returning to FIG. 4, the binder and Rubik's cube objects are used less frequently relative to the cup. In this arrangement, the LRU data structure, operating as a queue, once a smartphone object is added, the LRU object (e.g., binder) is removed, and the Rubik's cube now takes the final slot as the LRU object with the smartphone as the most recently used object. If the video application adds a new object to the list of allowed objects (e.g., a smartphone), the video application may determine whether the maximum threshold was exceeded. If the threshold is three, and the current amount of objects within the list of allowed objects is four, then the threshold is exceeded. The least recently used object (e.g., the binder) is removed from the list of allowed objects. The interface 410 has added the smartphone 412, which is now the most recently used object. The cup 408 is neither the most or least recently used object. The Rubik's cube 406 is now the current least recently used object (the binder has been removed). In some embodiments, the video application may implement other constraints other than least recently used functionality to the list of allowed objects to maintain a maximum threshold. In some embodiments, the video application may implement a preconfigured object expiry threshold, such that once the object expiry threshold is met, the object is removed from the list of allowed objects. In some embodiments, the video application may implement one or more of the above, or similar techniques, concurrently.

In some embodiments, the video application may process an audio input to determine that a word in the audio input is related to the detected first object. This may be helpful to increase the confidence level of object detection. In some embodiments, the video application may process the audio input using natural language processing (NLP), automatic speech recognition (ASR), generative AI modelling (e.g., large language model [LLM]) to transcribe audio input, and other text-to-speech technologies. The video application may add the first object to the list of allowed objects if there is detection in the video capture the first object, being held by the user, within the segmentation mask, and there is a determination that the word in the audio input is related to the detected first object. For example, if the user picks up his cup and holds it within his silhouette and speaks “this is my favorite cup!” The visual detection of the cup within the segmentation mask (e.g., user's silhouette) and the word “cup” in close temporal relation to the object held within the segmentation mask allow for the video application to select object with higher confidence. In some embodiments, the video application may receive training data that is based on historical video captures and historical audio inputs. For example, the training data may include general speech input (e.g., court testimony) that includes all types of general phenomena being spoken by various peoples of various backgrounds having various accents. The video application may train a machine learning model based on the received training data. For example, a neural network (e.g., in one variant which may be a convolutional neural network) may be employed and trained to listen to all the different variations of the word “cup”. Additionally, the neural network may visually determine thousands of variants of cups as it is trained on an assortment of video captures (e.g., kitchen footage from café videos). The video application may determine that the word in the audio input is related to the detected first object based on inputting the audio input and the video capture into the trained machine learning model. Continuing the example above, the neural network may set specific parameters and weights to determine that an audio input matches a visual object detection.

In some embodiments, the video application may query an external database to retrieve information regarding the detected first object. For example, the video application may detect a book and has a visual capture of the ISBN number. Based on the recorded ISBN number, the video application may query an external database (e.g., Amazon™) to determine alternate views of the book (e.g., alternate angles of the book cover). The video application may utilize the retrieved information from the query (e.g., the alternate angles) to confirm the detection of the first object (e.g., the book). This may also be useful as to not have duplicate entries into the list of allowed objects as the back cover visually differs from the front cover, even though it is the same object.

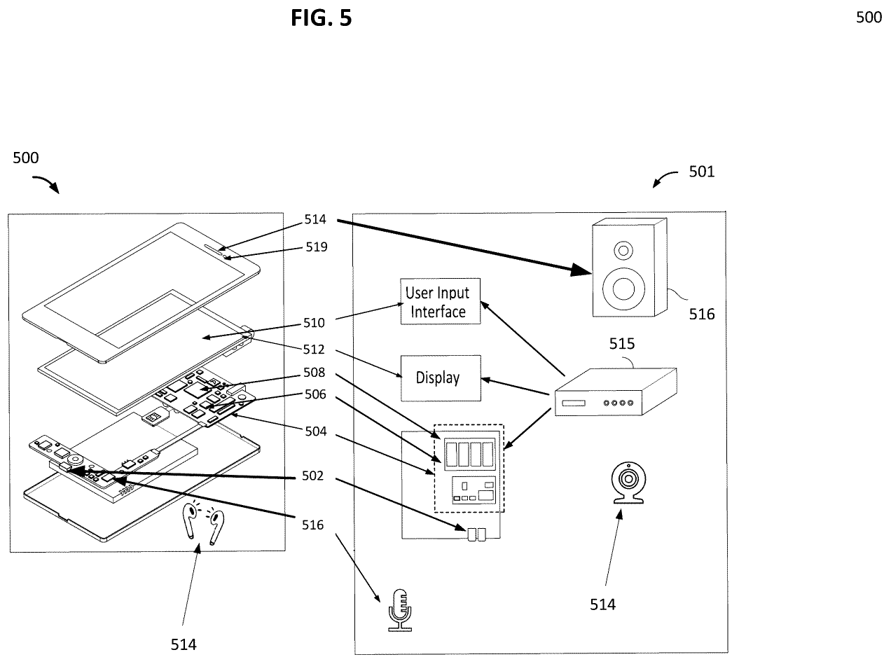

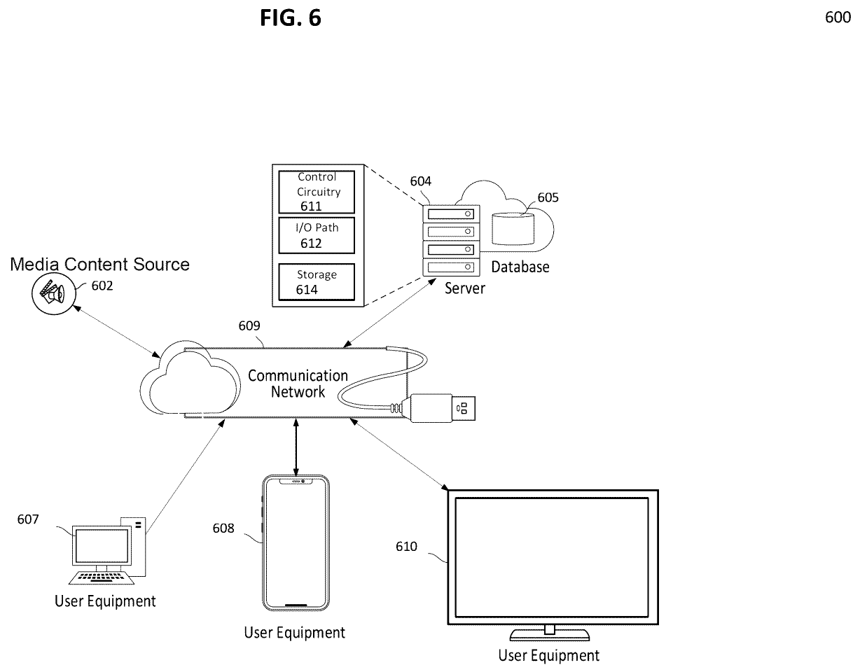

FIGS. 5-6 describe illustrative devices, systems, servers, and related hardware for a media application for efficient navigation of a plurality of media assets and for playing post-credit content in media assets by overriding play-next logic, in accordance with some embodiments of this disclosure. FIG. 5 shows generalized embodiments of illustrative user devices 500 and 501. For example, user equipment device 500 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 501 may be a user television equipment system or device. User television equipment device 501 may include set-top box 515. Set-top box 515 may be communicatively connected to microphone 516, audio output equipment (e.g., speaker or headphones 514), and display 512. In some embodiments, microphone 516 may receive audio corresponding to a voice of a user, e.g., a voice command. In some embodiments, display 512 may be a television display or a computer display. In some embodiments, set-top box 515 may be communicatively connected to user input interface 510. In some embodiments, user input interface 510 may be a remote control device. Set-top box 515 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 5. In some embodiments, device 500 may comprise any suitable number of sensors, as well as a GPS module (e.g., in communication with one or more servers and/or cell towers and/or satellites) to ascertain a location of device 500.

Each one of user equipment device 500 and user equipment device 501 may receive content and data via input/output (I/O) path 502. I/O path 502 may provide content (e.g., broadcast programming, on-demand programming, Internet content, content available over a local area network (LAN) or wide area network (WAN), and/or other content) and data to control circuitry 504, which may comprise processing circuitry 506 and storage 508. Control circuitry 504 may be used to send and receive commands, requests, and other suitable data using I/O path 502, which may comprise I/O circuitry. I/O path 502 may connect control circuitry 504 (and specifically processing circuitry 506) to one or more communications paths (described below). I/O functions may be provided by one or more of these communications paths, but are shown as a single path in FIG. 5 to avoid overcomplicating the drawing. While set-top box 515 is shown in FIG. 5 for illustration, any suitable computing device having processing circuitry, control circuitry, and storage may be used in accordance with the present disclosure. For example, set-top box 515 may be replaced by, or complemented by, a personal computer (e.g., a notebook, a laptop, a desktop), a smartphone (e.g., device 500), a tablet, a network-based server hosting a user-accessible client device, a non-user-owned device, any other suitable device, or any combination thereof.

Control circuitry 504 may be based on any suitable control circuitry such as processing circuitry 506. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for the Media application stored in memory (e.g., storage 508). Specifically, control circuitry 504 may be instructed by the Media application to perform the functions discussed above and below. In some implementations, processing or actions performed by control circuitry 504 may be based on instructions received from the Media application.

In client/server-based embodiments, control circuitry 504 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 5, the instructions may be stored in storage 508, and executed by control circuitry 504 of a device 500.

In some embodiments, the media application may be a client/server application where only the client application resides on device 500, and a server application resides on an external server (e.g., server 604 and/or server 616). For example, the media application may be implemented partially as a client application on control circuitry 504 of device 500 and partially on server 604 as a server application running on control circuitry 611. Server 604 may be a part of a local area network with one or more of devices 500 or may be part of a cloud computing environment accessed via the internet. In a cloud computing environment, various types of computing services for performing searches on the internet or informational databases, providing storage (e.g., for a database) or parsing data are provided by a collection of network-accessible computing and storage resources (e.g., server 604), referred to as “the cloud.” Device 500 may be a cloud client that relies on the cloud computing capabilities from server 604 to determine whether processing should be offloaded and facilitate such offloading. When executed by control circuitry 504 or 611, the media application may instruct control circuitry 504 or 611 circuitry to perform processing tasks for the client device and facilitate a media consumption session integrated with social network services. The client application may instruct control circuitry 504 to determine whether processing should be offloaded.

Control circuitry 504 may include communications circuitry suitable for communicating with a server, social network service, a table or database server, or other networks or servers The instructions for carrying out the above-mentioned functionality may be stored on a server (which is described in more detail in connection with FIG. 5). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as media application data described above. Nonvolatile memory may also be used (e.g., to launch a boot-up routine and other instructions). Cloud-based storage may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and downconverting content into the preferred output format of user equipment 500. Control circuitry 504 may also include digital-to-analog converter circuitry and analog-to-digital converter circuitry for converting between digital and analog signals. The tuning and encoding circuitry may be used by user equipment device 500, 501 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment device 500, the tuning and encoding circuitry (including multiple tuners) may be associated with storage 508.

Control circuitry 504 may receive instruction from a user by way of user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of each one of user equipment device 500 and user equipment device 501. For example, display 512 may be a touchscreen or touch-sensitive display. In such circumstances, user input interface 510 may be integrated with or combined with display 512. In some embodiments, user input interface 510 includes a remote-control device having one or more microphones, buttons, keypads, any other components configured to receive user input or combinations thereof. For example, user input interface 510 may include a handheld remote-control device having an alphanumeric keypad and option buttons. In a further example, user input interface 510 may include a handheld remote-control device having a microphone and control circuitry configured to receive and identify voice commands and transmit information to set-top box 515.

Audio output equipment 514 may be integrated with or combined with display 512. Display 512 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 512. Audio output equipment 514 may be provided as integrated with other elements of each one of device 500 and equipment 501 or may be stand-alone units. An audio component of videos and other content displayed on display 512 may be played through speakers (or headphones) of audio output equipment 514. In some embodiments, audio may be distributed to a receiver (not shown), which processes and outputs the audio via speakers of audio output equipment 514. In some embodiments, for example, control circuitry 504 is configured to provide audio cues to a user, or other audio feedback to a user, using speakers of audio output equipment 514. There may be a separate microphone 516 or audio output equipment 514 may include a microphone configured to receive audio input such as voice commands or speech. For example, a user may speak letters or words that are received by the microphone and converted to text by control circuitry 504. In a further example, a user may voice commands that are received by a microphone and recognized by control circuitry 504. Camera 518 may be any suitable video camera integrated with the equipment or externally connected. Camera 518 may be a digital camera comprising a charge-coupled device (CCD) and/or a complementary metal-oxide semiconductor (CMOS) image sensor. Camera 518 may be an analog camera that converts to digital images via a video card.

The media application may be implemented using any suitable architecture. For example, it may be a stand-alone application wholly-implemented on each one of user equipment device 500 and user equipment device 501. In such an approach, instructions of the application may be stored locally (e.g., in storage 508), and data for use by the application is downloaded on a periodic basis (e.g., from an out-of-band feed, from an Internet resource, or using another suitable approach). Control circuitry 504 may retrieve instructions of the application from storage 508 and process the instructions to provide media consumption and social network interaction functionality and generate any of the displays discussed herein. Based on the processed instructions, control circuitry 504 may determine what action to perform when input is received from user input interface 510. For example, movement of a cursor on a display up/down may be indicated by the processed instructions when user input interface 510 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 504 may allow a user to provide user profile information or may automatically compile user profile information. For example, control circuitry 504 may access and monitor network data, video data, audio data, processing data, participation data from a media application and social network profile. Control circuitry 504 may obtain all or part of other user profiles that are related to a particular user (e.g., via social media networks), and/or obtain information about the user from other sources that control circuitry 504 may access. As a result, a user can be provided with a unified experience across the user's different devices.

In some embodiments, the media application is a client/server-based application. Data for use by a thick or thin client implemented on each one of user equipment device 500 and user equipment device 501 may be retrieved on-demand by issuing requests to a server remote to each one of user equipment device 500 and user equipment device 501. For example, the remote server may store the instructions for the application in a storage device. The remote server may process the stored instructions using circuitry (e.g., control circuitry 504) and generate the displays discussed above and below. The client device may receive the displays generated by the remote server and may display the content of the displays locally on device 500. This way, the processing of the instructions is performed remotely by the server while the resulting displays (e.g., that may include text, a keyboard, or other visuals) are provided locally on device 500. Device 500 may receive inputs from the user via input interface 510 and transmit those inputs to the remote server for processing and generating the corresponding displays. For example, device 500 may transmit a communication to the remote server indicating that an up/down button was selected via input interface 510. The remote server may process instructions in accordance with that input and generate a display of the application corresponding to the input (e.g., a display that moves a cursor up/down). The generated display may then be transmitted to device 500 for presentation to the user.

In some embodiments, the media application may be downloaded and interpreted or otherwise run by an interpreter or virtual machine (run by control circuitry 504). In some embodiments, the media application may be encoded in the ETV Binary Interchange Format (EBIF), received by control circuitry 504 as part of a suitable feed, and interpreted by a user agent running on control circuitry 504. For example, the media application may be an EBIF application. In some embodiments, the media application may be defined by a series of JAVA-based files that are received and run by a local virtual machine or other suitable middleware executed by control circuitry 504. In some of such embodiments (e.g., those employing MPEG-2 or other digital media encoding schemes), the media application may be, for example, encoded and transmitted in an MPEG-2 object carousel with the MPEG audio and video packets of a program.

FIG. 6 is a diagram of an illustrative system 600, in accordance with some embodiments of this disclosure. User equipment devices 607, 608, 610 (e.g., user device; devices or any other suitable devices, or any combination thereof) may be coupled to communication network 606. Communication network 606 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 606.

System 600 may comprise media content source 602, one or more servers 604, and one or more social network services. In some embodiments, the media application may be executed at one or more of control circuitry 611 of server 604 (and/or control circuitry of user equipment devices 607, 608, 610.

In some embodiments, server 604 may include control circuitry 611 and storage 614 (e.g., RAM, ROM, Hard Disk, Removable Disk, etc.). Instructions for the media application may be stored in storage 614. In some embodiments, the media application, via control circuitry, may execute functions outlined in FIGS. 1-4. Storage 614 may store one or more databases. Server 604 may also include an input/output path 612. I/O path 612 may provide media consumption data, social networking data, device information, or other data, over a local area network (LAN) or wide area network (WAN), and/or other content and data to control circuitry 611, which may include processing circuitry, and storage 614. Control circuitry 611 may be used to send and receive commands, requests, and other suitable data using I/O path 612, which may comprise I/O circuitry. I/O path 612 may connect control circuitry 611 (and specifically control circuitry) to one or more communications paths. I/O path 612 may comprise I/O circuitry.

Control circuitry 611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 611 executes instructions for an emulation system application stored in memory (e.g., the storage 614). Memory may be an electronic storage device provided as storage 614 that is part of control circuitry 611.

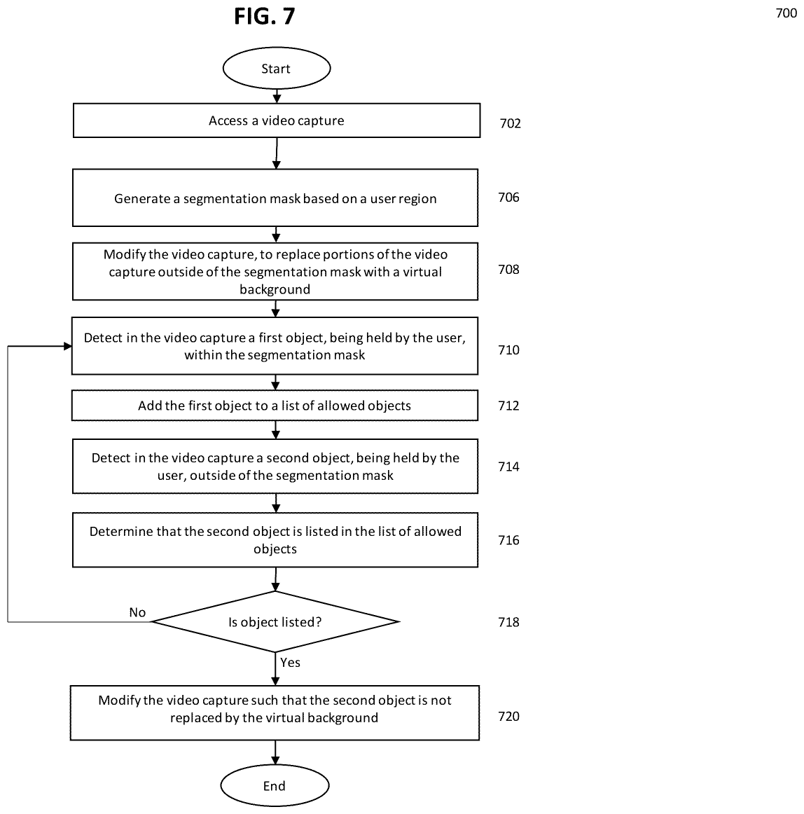

FIG. 7 is a flowchart of a detailed illustrative process 700 for modifying the video capture such that the second object is not replaced by the virtual background, in accordance with some embodiments of this disclosure. In various embodiments, the individual steps of process 700 may be implemented by one or more components of the devices and systems of FIGS. 1-6. Although the present disclosure may describe certain steps of process 700 (and of other processes described herein) as being implemented by certain components of the devices and systems of FIGS. 1-6, this is for purposes of illustration only, and it should be understood that other components of the devices and systems of FIGS. 1-6 may implement those steps instead.

At 702, the video application, via the control circuitry 611, accesses a video capture. In some embodiments, the video application may access the video capture from a user equipment 500, 607, 608, or 610. In some embodiments, the video application may access the video capture from storage 614. In some embodiments, the video application may access the video capture via the communication network 609 and/or I/O path 612.

At 706, the video application, via the control circuitry 611, generates a segmentation mask based a user region. In some embodiments, the video application may generate the segmentation mask using the I/O Path 612. In some embodiments, the video application may generate the segmentation mask on user equipment 500, 607, 608, or 610.

At 708, the video application, via the control circuitry 611, modifies the video capture, to replace portions of the video capture outside of the segmentation mask with a virtual background. In some embodiments, the video application may replace portions of the video capture via the I/O Path 612. In some embodiments, the video application may replace portions of the video capture on user equipment 500, 607, 608, or 610.

At 710, the video application, via the control circuitry 611, detects in the video capture a first object, being held by the user, within the segmentation mask. At 712, the video application, via the control circuitry 611, adds the first object to a list of allowed objects. In some embodiments, the video application may add via the database 605. In some embodiments, the video application may add via storage 614.

At 714, the video application, via the control circuitry 611, detects in the video capture a second object, being held by the user, outside of the segmentation mask. At 716, the video application, via the control circuitry 611, determines that the second object is listed in the list of allowed objects. If, at 718, the video application, via control circuitry 611, determines that the second object is not listed in the list of allowed objects, then the processing reverts to 710. If, at 718, the video application, via control circuitry 611, determines that the second object is listed in the list of allowed objects, then the processing proceeds to 720. At 720, the video application, via the control circuitry 611, modifies the video capture such that the second object is not replaced by the virtual background.

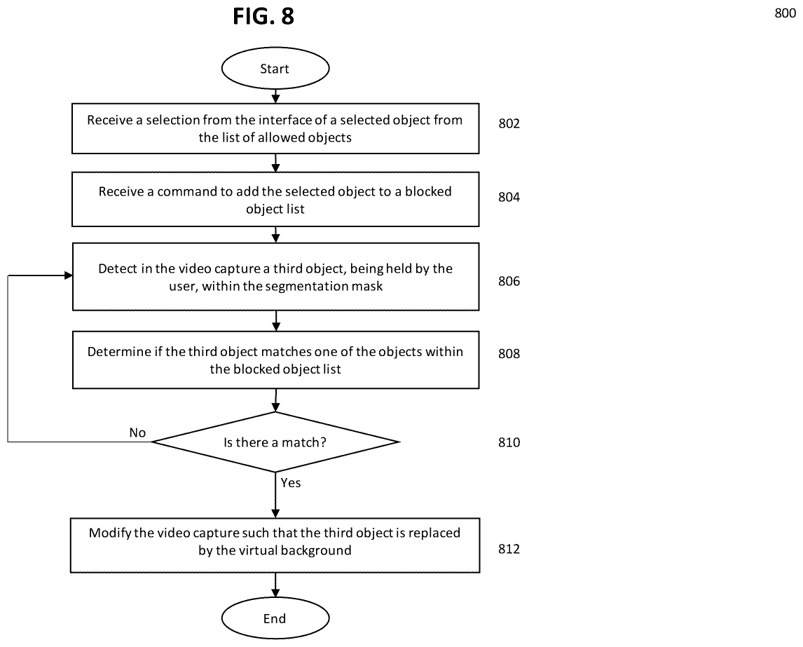

FIG. 8 is a flowchart of a detailed illustrative process 800 for modifying the video capture such that the third object is replaced by the virtual background, in accordance with some embodiments of this disclosure. At 802, the video application, via the control circuitry 611, receives a selection from the interface of a selected object from the list of allowed objects. In some embodiments, the selection is received from a user equipment 500, 607, 608, or 610. In some embodiments, the selection is received from storage 614. In some embodiments, the selection is received via the communication network 609 and/or I/O path 612.

At 804, the video application, via the control circuitry 611, receives a command to add the selected object to a blocked object list. In some embodiments, the command is received via the I/O Path 612. In some embodiments, the command is received from user equipment 500, 607, 608, or 610.

At 806, the video application, via the control circuitry 611, detects in the video capture a third object, being held by the user, within the segmentation mask. At 808, the video application, via the control circuitry 611, determines if the third object matches one of the objects within the blocked object list. If, at 810, the video application, via control circuitry 611, determines that the third object does not match one of the objects within the blocked object list, then the processing reverts to 806. If, at 810, the video application, via control circuitry 611, determines the third object matches one of the objects within the blocked object list, then the processing proceeds to 812. At 812, the video application, via the control circuitry 611, modifies the video capture such that the third object is replaced by the virtual background.

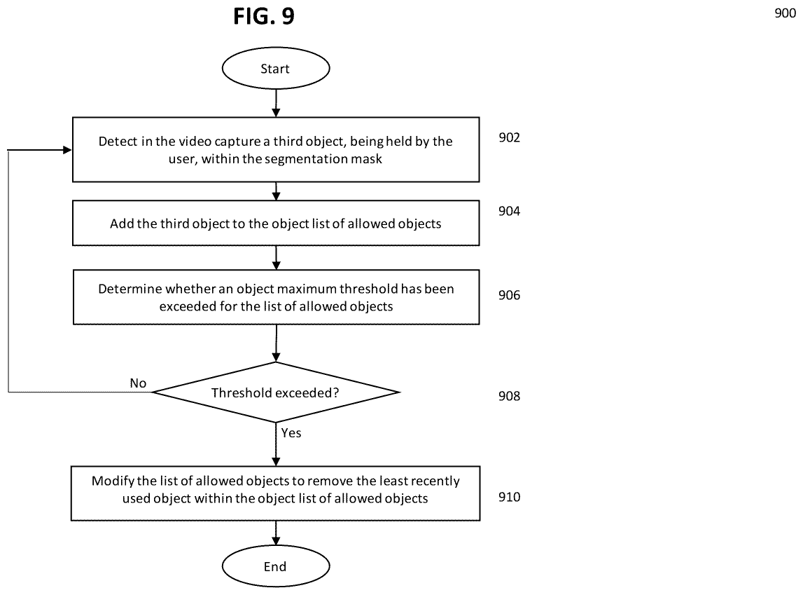

FIG. 9 is a flowchart of a detailed illustrative process 900 for modifying the list of allowed objects to remove the least recently used object within the object list of allowed objects, in accordance with some embodiments of this disclosure. At 902, the video application, via the control circuitry 611, detects in the video capture a third object, being held by the user, within the segmentation mask. In some embodiments, the list of allowed objects is stored in at least one of server 604, database 605, or storage 614.

At 904, the video application, via the control circuitry 611, adds the third object to the object list of allowed objects. At 906, the video application, via the control circuitry 611, determines whether an object maximum threshold has been exceeded for the list of allowed objects. If, at 908, the video application, via control circuitry 611, the object maximum threshold has not been exceeded for the list of allowed objects, then the processing reverts to 902. If, at 810, the video application, via control circuitry 611, determines the object maximum threshold has been exceeded for the list of allowed objects, then the processing proceeds to 910. At 910, the video application, via the control circuitry 611, modifies the list of allowed objects to remove the least recently used object within the object list of allowed objects.

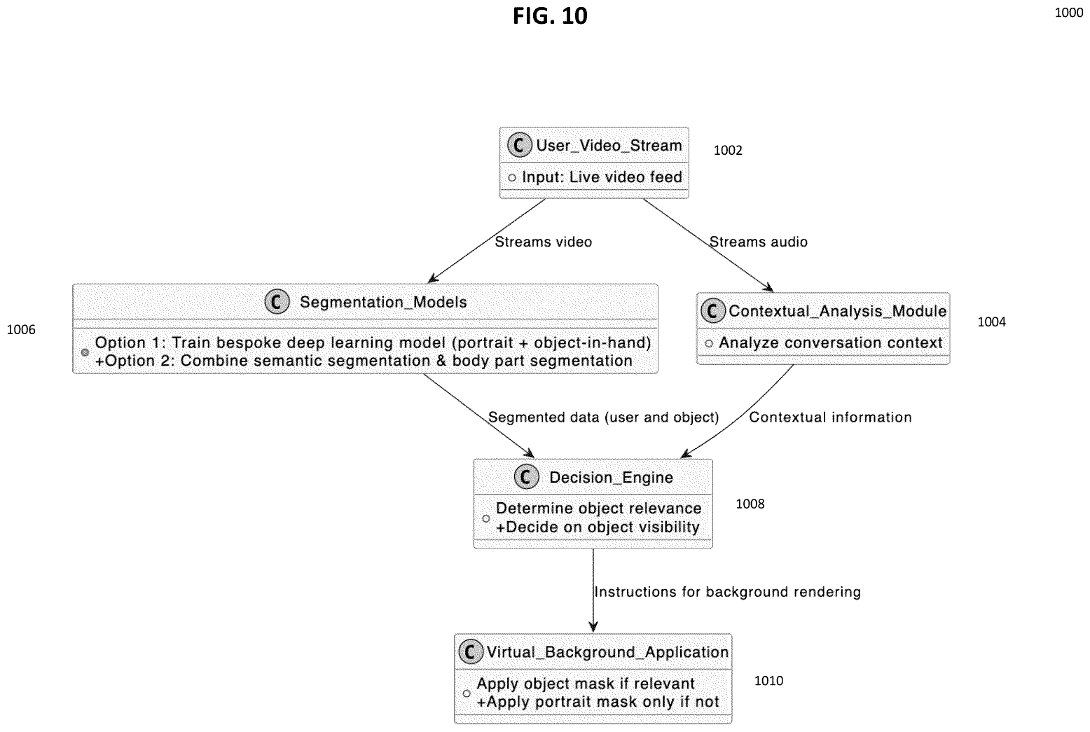

FIG. 10 is a flow diagram of a detailed illustrative process 1000 for applying a segmentation mask, in accordance with some embodiments of this disclosure. In this embodiment, the video application implements a segmentation model that segments the user and the detected object held by the user. A single deep learning-based model is trained that segments the user from the detected held object. This model may then classify the detected held object. This may be implemented by having the video application utilize semantic segmentation models and body part segmentation models to identify the detected object by associating the detected object segments with the hand segments in the video, utilizing motion cues.

The video application may also implement NLP to analyze audio inputs such that a decision engine may determine that the detected object is confirmed. In some embodiments, the video application may determine a first region of the video capture that is related to the user region (e.g., a user in front of a virtual background). The video application may then determine a second region of the video capture that is related to the first object being held by the user, within the segmentation mask (e.g., the user is holding a pen). The video application may then process an audio input to determining that a word in the audio input is related to the detected first object (e.g., the user states “this is my favorite pen.” The video application may then input the first region, the second region, and the audio input into a semantic segmentation model to confirm the first object exceeds a confidence threshold. In some embodiments, the confidence threshold may be preset or adjustable. In some embodiments, the confidence threshold may be determined dynamically based on historical functions and iterations performed by the semantic segmentation model.

At 1002, the video application, via control circuitry 611, receives a user video capture (e.g., video stream). The video application, via control circuitry 611, bifurcates the video capture into the user region that captures the body of the user and secondly the first object being held by the user (1006). The video application may also implement an audio contextual analysis module to analyze the audio inputs (1004). The video application, via control circuitry 611, implements a decision engine to determine object relevance based on both audio and video (1008). The video application applies an object segmentation mask based on this relevance (1010).

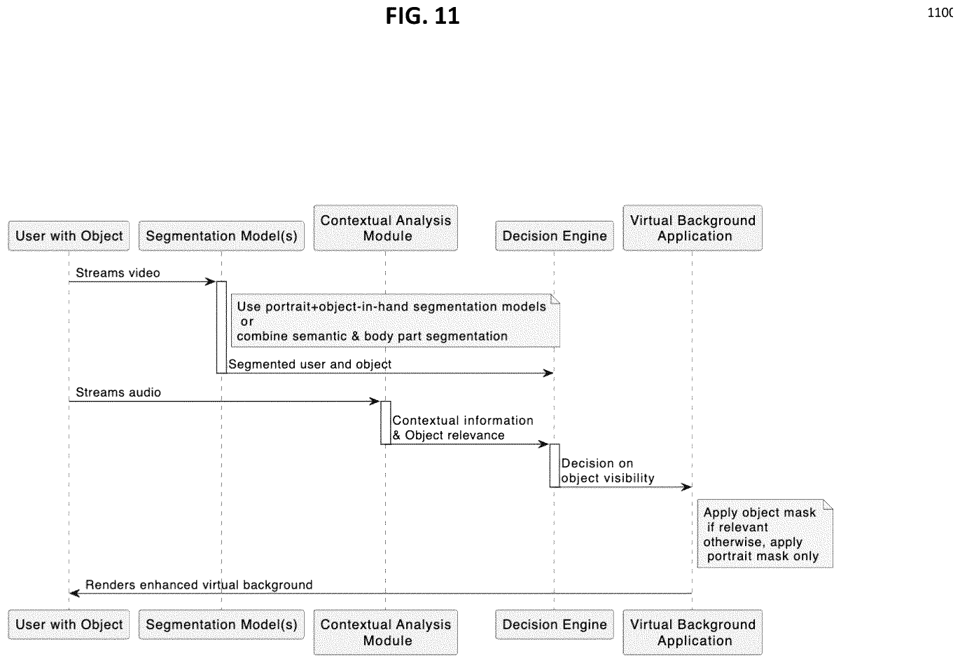

FIG. 11 is a flow diagram of another detailed illustrative process 1100 for applying a segmentation mask, in accordance with some embodiments of this disclosure. A video capture of a user with an object is streamed to a video application that, via control circuitry 611, bifurcates the video capture into audio and video. The video application, via control circuitry 611, implements segmentation models. In one embodiment, the segmentation model operates based on portrait+object-in-hand. In another embodiment, the segmentation model combines semantic and body part segmentation models. The video application, via control circuitry 611, implements a contextual analysis module that contextualizes information and object relevance from the audio input. The video application, via control circuitry 611, implements a decision engine module that determines whether a segmentation mask (e.g., visibility) should be applied to the object. If so, a virtual background is applied (e.g., via virtual background application).

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
accessing a video capture;
generating a segmentation mask based on a user region;
modifying the video capture, to replace portions of the video capture outside of the segmentation mask with a virtual background;
detecting in the video capture a first object, being held by the user, within the segmentation mask;
adding the first object to a list of allowed objects;
detecting in the video capture a second object, being held by the user, outside of the segmentation mask;
determining that the second object is listed in the list of allowed objects; and
modifying the video capture such that the second object is not replaced by the virtual background.

2. The method of claim 1, further comprising:
in response to determining that (a) that the second object is not being held by the user, and (b) that the second object is outside of the segmentation mask:
modifying the video capture to replace the second object with the virtual background.

3. The method of claim 2, wherein the modifying the video capture to replace the second object with the virtual background further comprises gradually increasing transparency of the second object until the second object is fully transparent.

4. The method of claim 1, further comprising:
generating for display an indication of designated object recognition zone; and
in response to detecting in the video capture a third object, being held by the user, within the designated object recognition zone:
adding the third object to the list of allowed objects.

5. The method of claim 1, further comprising:
generating for display an interface, wherein the interface comprises identifiers of one or more objects within the list of allowed objects.

6. The method of claim 5, further comprising:
receiving a selection from the interface of a selected object from the list of allowed objects;
receiving a command to add the selected object to a blocked objects list;
detecting in the video capture a third object, being held by the user, within the segmentation mask;
determining that the third object matches one of objects within the blocked object list; and
in response to the determining that the third object matches one of objects within the blocked objects list, modifying the video capture such that the third object is modified to be transparent.

7. The method of claim 5, further comprising:
detecting in the video capture a third object, being held by the user, within the segmentation mask;
adding the third object to the list of allowed objects; and
in response to determining that a maximum threshold has been exceeded for the list of allowed objects:
modifying the list of allowed objects to remove least recently used object within the list of allowed objects.

8. The method of claim 1, wherein the virtual background comprises at least one of: a static background, a dynamic background, or a modified visual effect applied to the transmitted background.

9. The method of claim 1,
processing an audio input to determining that a word in the audio input is related to the detected first object;
wherein the adding the first object to the list of allowed objects is performed in response to: (a) detecting in the video capture the first object, being held by the user, within the segmentation mask, and (b) the determining that the word in the audio input is related to the detected first object.

10. The method of claim 1, further comprising:
determining a first region of the video capture, wherein the first region is related to the user region;
determining a second region of the video capture, wherein the second region is related to the first object being held by the user, within the segmentation mask;
processing an audio input to determining that a word in the audio input is related to the detected first object;
inputting the first region, the second region, and the audio input into a semantic segmentation model; and
confirming, based on the semantic segmentation model, the first object exceeds a confidence threshold.

11. A system comprising:
control circuitry configured to:
access a video capture;
generate a segmentation mask based on a user region;
modify the video capture, to replace portions of the video capture outside of the segmentation mask with a virtual background;
detect in the video capture a first object, being held by the user, within the segmentation mask;
add the first object to a list of allowed objects;
detect in the video capture a second object, being held by the user, outside of the segmentation mask;
determine that the second object is listed in the list of allowed objects; and
modify the video capture such that the second object is not replaced by the virtual background.

12. The system of claim 11, wherein the control circuitry is further configured to:
in response to determining that (a) that the second object is not being held by the user, and (b) that the second object is outside of the segmentation mask:
modify the video capture to replace the second object with the virtual background.

13. The system of claim 12, wherein the control circuitry is configured to, when modifying the video capture to replace the second object with the virtual background, to gradually increase transparency of the second object until the second object is fully transparent.

14. The system of claim 11, wherein the control circuitry is further configured to:
generate for display an indication of designated object recognition zone; and
in response to detecting in the video capture a third object, being held by the user, within the designated object recognition zone:
add the third object to the list of allowed objects.

15. The system of claim 11, wherein the control circuitry is further configured to:
generate for display an interface, wherein the interface comprises identifiers of one or more objects within the list of allowed objects.

16. The system of claim 15, wherein the control circuitry is further configured to:
receive a selection from the interface of a selected object from the list of allowed objects;
receive a command to add the selected object to a blocked objects list;
detect in the video capture a third object, being held by the user, within the segmentation mask;
determine that the third object matches one of objects within the blocked object list; and
in response to the determining that the third object matches one of objects within the blocked objects list, modify the video capture such that the third object is modified to be transparent.

17. The system of claim 15, wherein the control circuitry is further configured to:
detect in the video capture a third object, being held by the user, within the segmentation mask;
add the third object to the list of allowed objects; and
in response to determining that a maximum threshold has been exceeded for the list of allowed objects:
modify the list of allowed objects to remove least recently used object within the list of allowed objects.

18. The system of claim 11, wherein the virtual background comprises at least one of: a static background, a dynamic background, or a modified visual effect applied to the transmitted background.

19. The system of claim 11,
process an audio input to determine that a word in the audio input is related to the detected first object;
wherein the control circuitry is configured to add the first object to the list of allowed objects is performed in response to: (a) detecting in the video capture the first object, being held by the user, within the segmentation mask, and (b) the determining that the word in the audio input is related to the detected first object.

20. (canceled)

21. A system comprising:
means for accessing a video capture;
means for generating a segmentation mask based on a user region;
means for modifying the video capture, to replace portions of the video capture outside of the segmentation mask with a virtual background;
means for detecting in the video capture a first object, being held by the user, within the segmentation mask;
means for adding the first object to a list of allowed objects;
means for detecting in the video capture a second object, being held by the user, outside of the segmentation mask;
means for determining that the second object is listed in the list of allowed objects; and
means for modifying the video capture such that the second object is not replaced by the virtual background.

22-50. (canceled)
